(19) United States
(12) Patent Application Publication
(10) Pub. No.: US 2022/0013000 A1
(43) Pub. Date: Jan. 13, 2022

(54) PORTABLE DEVICES, SYSTEMS AND METHODS FOR ALERT NOTIFICATION

(71) Applicants: JUNMING DING, Shanghai (CN); Rayford Higginbotham, Huntington Beach, CA (US); Chengping Chen, Irvine, CA (US)

(72) Inventors: JUNMING DING, Shanghai (CN); Rayford Higginbotham, Huntington Beach, CA (US); Chengping Chen, Irvine, CA (US)

(21) Appl. No.: 16/926,601

(22) Filed: Jul. 10, 2020

(51) Int. Cl. G08B 25/01; G08B 25/10; G08B 21/18; G08B 21/02; G08B 5/36; H04W 4/02; H04W 4/14; H04W 4/80; H04W 4/90

(52) U.S. Cl. CPC G08B 25/016; G08B 25/10; G08B 21/182; G08B 21/02; H04W 4/90; H04W 4/027; H04W 4/14; H04W 4/80; G08B 5/36

(57) ABSTRACT

Portable devices, systems and methods for alert notification are provided. The systems may include a portable device, a remote server and an external communication device. The portable device comprises wireless communication circuitry, at least one sensor and a processor. The at least one sensor may be configured to detect a condition in which the portable device is exposed and to output an associated sensor data. The processor may be configured to receive an input signal associated with an activation of an emergency mode, and in response to the receipt of the input signal, transmit an output signal for transmission by the wireless communication circuitry. The output signal providing an alert notification at the external communication device. The alert notification comprising the sensor data from the at least one sensor, and may be provided as a software application message or an SMS message.

### RELATED APPLICATIONS

This application is related to concurrently filed, co-pending, and commonly assigned U.S. application Ser. No. [Attorney Docket No. ATEL-21498-UA], entitled “Multi-Mode Portable Lighting Devices, Systems And Methods With Novel Battery Charging Unit,” the disclosure of which is incorporated herein by reference in its entirety.

### FIELD OF THE INVENTION

This patent document relates to portable electronic devices, including, for example, flashlights, headlamps and their circuitry. More particularly the subject matter of this patent document relates to portable electronic devices, systems and method for alert notification.

### DESCRIPTION OF THE RELATED ART

Light sources, such as flashlights or headlamps, are widely used in households. They are also used by various professions, such as police, firemen, military and security personnel, as well as used for various activities, such as extreme sports, camping, walking, jogging or other activities in low-lit areas. Moreover, light sources are commonly used in emergency situations that may be unsafe, due to a power failure or in a remote area with risk to safety.

Despite the use of light sources for a long time, improvements made to these devices as compared to other consumer electronics have been minimal. Prior art light sources generally don't give the user valuable information relating to the light source or its location, such as GPS location, temperature or accelerometer data, nor do known light sources provide a capability to alert others in the case of an emergency or a threat to personal safety.

The threat to personal safety remains very real. Indeed, the number of violent crimes rose from 2.7 million in 2015 to 3.3 million in 2018, including rape or sexual assault, aggravated assault and simple assault. According to Rape, Abuse & Incest National Network (RAINN), an American is sexually assaulted every 73 seconds, and every 9 minutes, that victim is a child. See www.rainn.org/statistics. Meanwhile, according to FBI records, the National Crime Information Center (NCIC) had 612,846 missing person records entered in 2018, with juveniles under the age of 18 amount to 34.8% of the records. See https://www.fbi.gov/file-repository/2018-ncic-missing-person-and-unidentied-person-statisties.pdf. The threat to personal safety is also real to the elderly. Every 11 seconds, an elderly person is treated in the ER for a fall and every 19 minutes, an elderly person dies from a fall. Indeed, falls result in more than 2.8 million injuries treated in ER departments annually. Thus, with the rise in threat to personal safety, the need for improvements to light sources, used for example in remote areas or in emergency situations, still remains.

The present disclosure provides an improved portable light source, such as a flashlight or a headlamp, integrated in a unique and inventive alert notification solution that may optionally be associated with a software App running on a smart device, such as a cell-phone or tablet.

### SUMMARY

Portable devices, systems and methods for alert notification are provided. In one embodiment, the alert notification system includes a portable device, a remote server and an external communication device. The portable device may include a wireless communication circuitry, at least one sensor and a processor. The at least one sensor may be configured to detect a condition in which the portable device is exposed and to output an associated sensor data. The at least one sensor comprising a Global Positioning Satellite (GPS) locator. The processor may be operatively coupled to the at least one sensor and the wireless communication circuitry. The processor may be configured to receive an input signal associated with an activation of an emergency mode, and in response to the receipt of the input signal, transmit an output signal for transmission by the wireless communication circuitry, the output signal comprising the sensor data from the at least one sensor and an identification information of the portable device.

The remote server may be wirelessly coupled to the portable device. The remote server may be configured to receive the output signal from the wireless communication circuitry of the portable device, retrieve from a storage medium a user's emergency alert setting based on the identification information of the portable device, and transmit an alert notification based on the emergency alert setting. Meanwhile, the external communication device may be wirelessly coupled to the remote server. The external communication device may be configured to receive the alert notification from the remote server, whereby the alert notification includes the sensor data from the at least one sensor.

In one embodiment, the portable device is a portable flashlight. In another embodiment, the remote server may transmit an emergency medical service code to alert local authorities. In yet another embodiment, the emergency alert setting may include a mobile phone number of at least one emergency contact. The remote server may transmit the alert notification to the at least one emergency contact by an SMS message.

As can be appreciated, the at least one sensor may further comprise a temperature sensor, an accelerometer, a pedometer, or any combination of any of the foregoing. The portable device may further comprise at least one control switch, the at least one control switch configured for activation of the emergency mode.

In one embodiment, the activation of the emergency mode may be triggered automatically based on a predetermined condition, for example, by a detection by the temperature sensor of a temperature above a certain temperature threshold level, a detection by the accelerometer of a certain change in elevation within a predetermined period, and/or a detection by the accelerometer of a vibration above a certain threshold level.

In yet another embodiment, a portable lighting device is provided. The portable lighting device has a housing having a proximal end and a distal end, and is defining a hollow cavity. A light source may be disposed at the proximal end of the housing. Meanwhile, disposed in the cavity of the housing may be at least one control switch, wireless communication circuitry, at least one sensor and a processor. The at least one control switch may be configured for activation of an emergency mode, the wireless communication circuitry may be configured for wireless transmission through a wireless link, and the at least one sensor may be configured to detect a condition in which the portable device is exposed and to output an associated sensor data. The at least one sensor may include an accelerometer, a Global Positioning Satellite (GPS) locator and/or a temperature sensor. The processor may be operatively coupled to the at least one control switch, the at least one sensor and the wireless communication circuitry. The processor may be configured to receive a signal from the at least one control switch for activation of the emergency mode, and send an associated output signal for transmission by the wireless communication circuitry, the associated output signal comprising the sensor data from the at least one sensor and an identification information of the portable device.

In one embodiment, the light source may be configured to emit an SOS distress lighting pattern when the emergency mode is activated. In another embodiment, the activation of the emergency mode is triggered automatically based on a predetermined sensor condition, which may be a detection by the temperature sensor of a temperature above a certain temperature threshold level, a detection by the accelerometer of a certain change in elevation within a predetermined period of time, and/or a detection by the accelerometer of a vibration above a certain threshold level. As can be appreciated, the output signal may be transmitted by the wireless communication circuitry to an external communication device through the wireless link. The output signal may provide an alert notification at the external communication device, which may include the sensor data from the at least one sensor. In one embodiment, the portable lighting device also includes a rechargeable battery electrically coupled to the light source, wherein the wireless communication circuitry may be further configured to transmit a battery condition information of the rechargeable battery to an external communication device through the wireless link. The wireless communication circuitry may be Bluetooth circuitry, Wi-Fi circuitry and wireless mobile communication circuitry.

In yet another embodiment, a portable device for alert notification is provided. The portable device includes wireless communication circuitry, at least one sensor (for example, an accelerometer) and a processor. The processor may be operatively coupled to the at least one sensor and the wireless communication circuitry. The processor may be configured to: (a) receive the sensor data from the at least one sensor, (b) automatically activate an emergency mode based on a predetermined sensor condition, (c) automatically send an output signal for transmission by the wireless communication circuitry. The predetermined sensor condition may include sensor data associated with a detection by the accelerometer of a certain change in elevation within a predetermined period and/or a detection by the accelerometer of a vibration above a certain threshold level. The output signal may comprise the sensor data from the accelerometer and identification information of the portable device. The output signal may be transmitted by the wireless communication circuitry to an external communication device through a wireless link, and may provide an alert notification at the external communication device via a software application message or an SMS message.

Each of the foregoing various aspects, together with those set forth in the claims and described in connection with the embodiments summarized above and disclosed herein may be combined to form claims for a device, apparatus, system, methods of manufacture and/or use in any way disclosed herein without limitation.

### BRIEF DESCRIPTION OF THE DRAWINGS

These and other features, aspects and advantages are described below with reference to the drawings, which are intended to illustrate but not to limit the invention. In the drawings, like reference characters denote corresponding features consistently throughout similar embodiments.

FIG. 1 is a front side perspective view of a portable device, such as a portable flashlight, according to an embodiment.

FIG. 2 is a front plan view of the portable device of FIG. 1, according to an embodiment.

FIG. 3A is a rear plan view of the portable device of FIG. 1 with a cover for the power connector port, according to an embodiment.

FIG. 3B is a rear plan view of the portable device of FIG. 1 without a cover for the power connector port, according to another embodiment.

FIG. 4 is a top view of the portable device of FIG. 1, according to an embodiment.

FIG. 5 is a bottom of the portable device of FIG. 1, according to an embodiment.

FIG. 6A is a right side view of the portable device of FIG. 1, according to an embodiment.

FIG. 6B is a left side view of the portable device of FIG. 1, according to an embodiment.

FIG. 7 is a cross-sectional view of the portable device of FIG. 1 taken along cut line 7-7 in FIG. 1.

FIG. 8 is an exemplary block diagram illustrating circuitry of a portable device, according to an embodiment.

FIG. 9 is a flowchart illustrating exemplary operational features of a communication system for alert notification, according to an embodiment.

FIG. 10 is an exemplary block diagram of a communication system for alert notification, according to an embodiment.

FIG. 11 is an exploded view of the portable device of FIG. 1, according to an embodiment.

FIG. 12 is an exemplary display view on a mobile device when an app is used with the portable device, according to an embodiment.

### DETAILED DESCRIPTION

Unique and inventive portable devices, systems and methods of operation are disclosed herein. In one embodiment, the portable device may be a flashlight or a headlamp. Examples of flashlights are described in U.S. Pat. Nos. 8,366,290, 8,169,165 and 9,671,102, the disclosures of which are specifically incorporated by reference in their entirety. Although flashlight embodiments are disclosed herein, it is to be expressly understood that the present invention is not restricted solely to such embodiments. Rather, the present disclosure is directed to each of the inventive features described below, both individually as well as collectively, in various embodiments. Further, as will become apparent to those skilled in the art, one or more aspects of the present disclosure may be incorporated in other portable lighting devices, for example, headlamps.

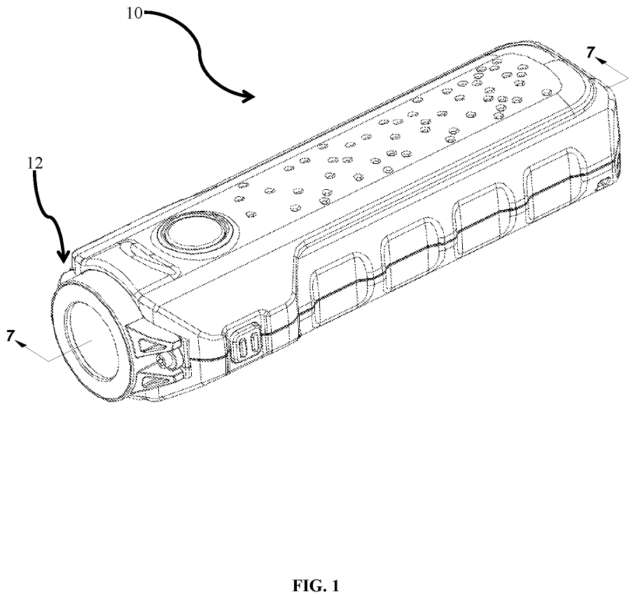

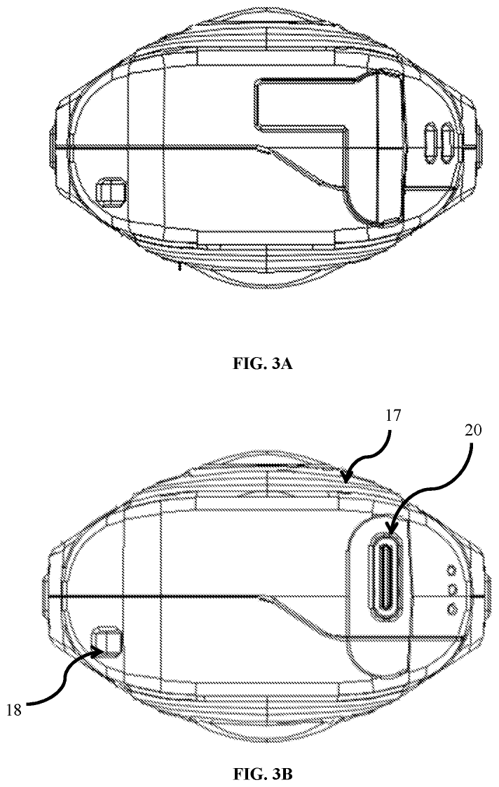

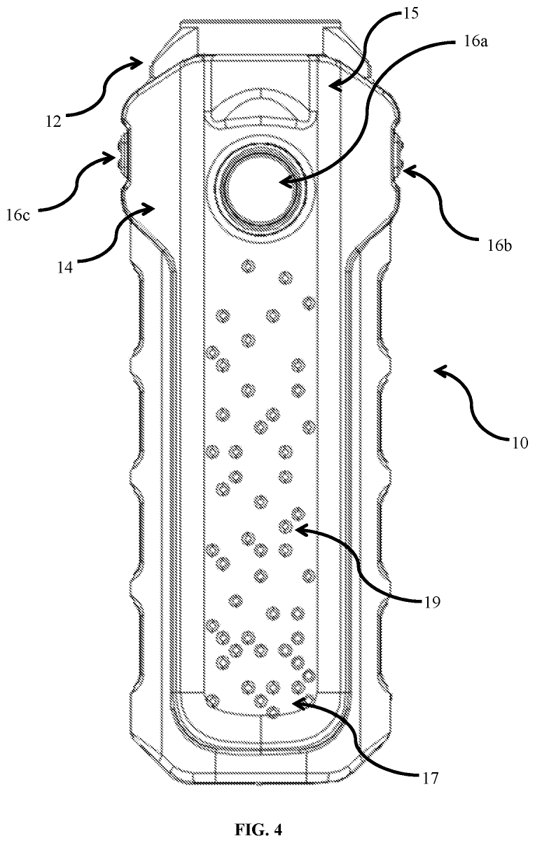

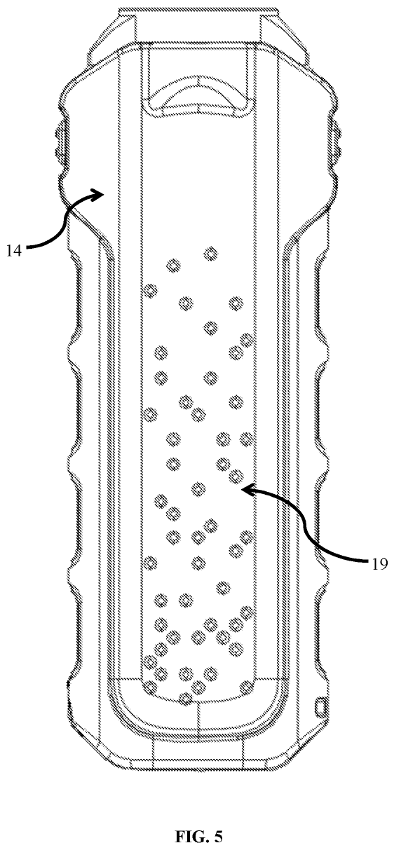

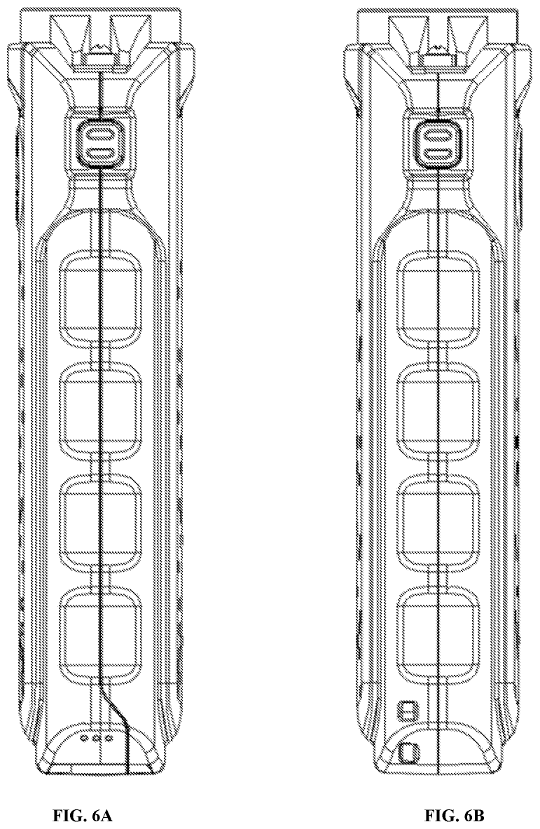

FIGS. 1-6 disclose a portable device, such as flashlight 10, according to an embodiment. Flashlight 10 may include a head assembly 12, a housing 14, one or more control switches 16 (e.g., 16a, 16b, 16c), a speaker 18, and power connector port 20. The head assembly 12 is disposed about the forward end of the housing 14. The housing 14 has a proximal end 15 and a distal end 17. The housing 14 may define a hollow cavity for receiving flashlight internal components. Housing 14 may also include one or more apertures and mounting features for mounting exterior components of the flashlight 10, such as the head assembly 12, switches 16, and connector port 20 and for permitting such components to be operatively connected to the internal components and circuitry of the flashlight 10. Housing 14 may also include an exterior surface with elongated gripping portion 19. In one embodiment, the power connector port 20 may be disposed about the distal end 17 of the housing 14, and the control switches 16 may be disposed on the top and/or a side of the housing 14. In other embodiments, the power connector port 20 and the control switch 16 may be advantageously positioned elsewhere on or about the housing 14.

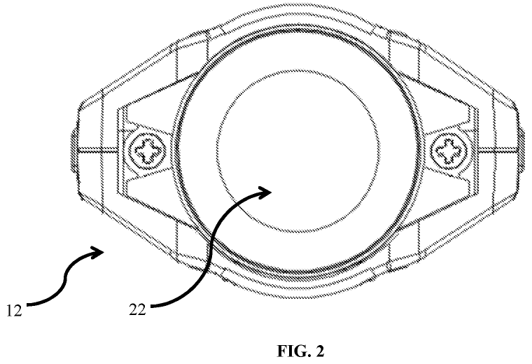

As can be appreciated, the one or more control switches 16 may be used to control an actuation of the flashlight 10, a selection of ON/OFF power, a selection of Mode change, a status check on the flashlight 10, and/or an actuation of an alert SOS feature, among others. These features may be controlled through several control switches 16 on the flashlight 10. Alternatively, the features may be controlled though an integrated control switch 16. As shown in the exemplary embodiment on FIGS. 1-2, the flashlight 10 includes a top control switch 16a that may be used to control the actuation of a light source 22 (i.e. LED), a first side control switch 16b that may be used to control actuation and/or selection of LED lighting mode and power ON/OFF, and a second side control switch 16c that may be used to control actuation of device status check for wireless signal and/or battery capacity, among others. In another embodiment, the first side control switch 16b may be used for auxiliary features, such as a momentary flash feature, which momentarily flashes the light, or turn on warning LEDs or audio feature, and the second side control switch 16c may be used as a power ON/OFF of the device with a long press (i.e. 5 second press) and/or used as a “check” button to check device status, such as network connectivity, GPS lock and battery level.

As can be appreciated, the battery status check may be triggered with a single actuation of the second side control switch 16c, and may be configured to provide a warning LED or preset audio alert from speaker 18. For example, for an audio alert, the message may be full, above 80%, above 60%, above 40% and/or low. As another example, for warning LEDs, a blue light for a certain time period, i.e., 3 seconds, may represent battery above 80%, a yellow light may represent battery at or about 40%, and a red light may represent that the battery is low. Moreover, the network connectivity status check may, for example, be triggered with a double actuation of the second side control switch 16c, and may also be configured to provide a warning LED or preset audio alert from speaker 18. For example, for an audio alert, the message may “Good Network and GPS Signal,” “GPS Signal Lost,” and/or “All Signal Lost.” As another example, for warning LEDs, a blue light for a certain time period, i.e., 3 seconds, may represent good signal, a yellow light may represent no GPS, and a red light may represent all signal lost.

In one embodiment, the light source 22 may be triggered to turn on momentarily with the actuation of the first side control switch 16b, and turns off when the first side control switch 16b is released. In another embodiment, the audio alert for battery status may be turned on/off with the actuation of the first side control switch 16b. For example, when actuating the first side control switch 16b for a certain period, i.e. 2 seconds, then the audio speaker 18 is turned ON/OFF for replay of preset audio alert.

In yet another embodiment, the top control switch 16a may be used to actuate the LED light source 22, and may be programmed with different LED light modes that change depending on the number of times the top control switch 16a is actuated and the sequence, for example, every actuation of the top control switch 16a may toggle through the actuation of one or more of the following exemplary operating modes of the light source: high, mid, low, fast-flashing, slow-flashing, etc.

In an alternative embodiment, the one or more control switches 16 may be depressed together to actuate other operations. For example, the first side control switch 16b and the second side control switch 16c may be depressed simultaneously to actuate an emergency mode (i.e. SOS alert or panic). Alternatively, the emergency mode may be triggered automatically under certain conditions, GEO Fencing, fall/crash detection or high temperature detection.

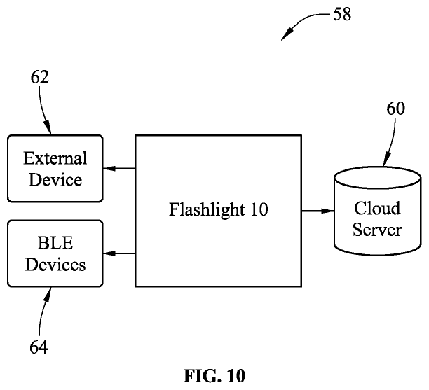

When the emergency mode is triggered, the light source 22 may be actuated to emit an SOS distress lighting pattern. In another embodiment, when the emergency mode is triggered, the speaker 18 may play preset audio to the user, for example, indicating that the emergency mode has been activated and/or an alert has been sent for the local authorities and/or to one or more pre-selected personal contacts. As explained further below, in emergency mode, the flashlight 10 may be configured to transmit an alert message (i.e. an SOS code) to a remote server 60 (shown in FIG. 10) via wireless communication. The remote server 60 may be configured to send alert notification for local authorities and/or to one or more pre-selected personal contacts. The personal contacts may be alerted via an App or by SMS. As can be appreciated, the user of flashlight 10 may input the mobile phone numbers of the pre-selected personal contacts via, for example, a phone App. The input mobile phone numbers may be transmitted and saved on the remote server 60, and thereafter, used to alert the personal contacts when the emergency mode on the flashlight 10 is actuated by the user at a later time. As such, personal contacts not using a phone App or who have their phone App turned off or disabled, are still able to receive an alert notification of the emergency via an SMS text message.

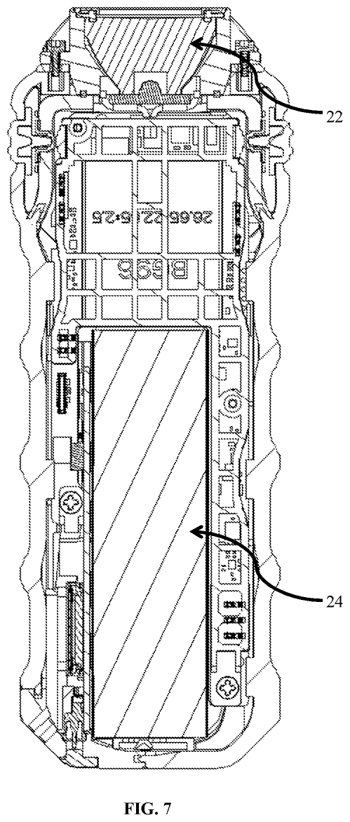

FIG. 7 is a cross-sectional view of the portable device of FIG. 1 taken through the plane indicated by 7-7 in FIG. 1. A light source 22 is disposed at the proximal end 15 of the housing 14, preferably at a distal end of head assembly 12. In one embodiment, the light source 22 may be a Light Emitting Diode (LED), but may also include an incandescent light source, such as halogen light source, xenon light source, krypton light source or tungsten-filament light source. In one embodiment, the light intensity output of the light source 22 may range from about 100 Lumens to about 10000 Lumens depending on the flashlight model. Desirably, the light intensity output of the light source 22 may range from about 100 Lumens to about 4000 Lumens.

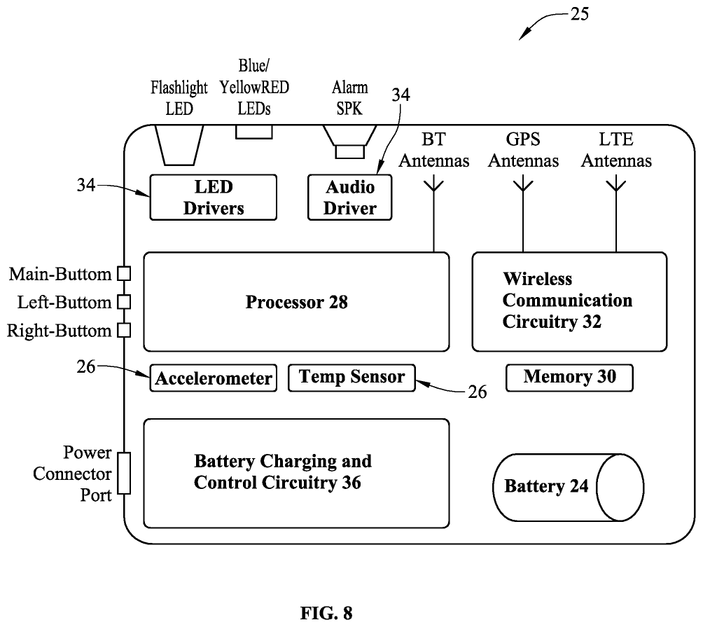

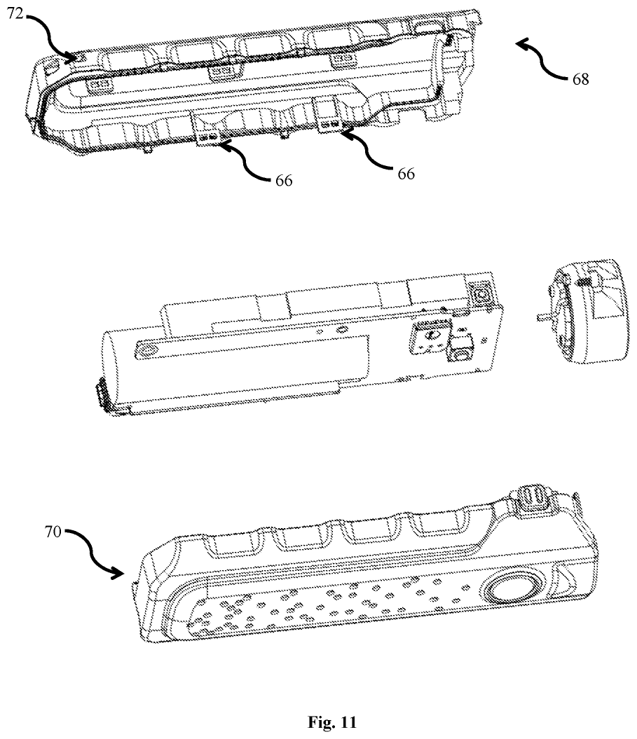

FIG. 8 is an exemplary block diagram 25 illustrating circuitry of the portable device of FIG. 1, according to an embodiment. The portable device may include, for example, a battery bank 24, one or more sensors 26, a processor 28, a memory 30, a wireless communication circuitry 32, a DC-DC switch (not shown), one or more drivers 34, and a battery charging and control circuitry 36. In one embodiment, the battery bank 24 comprises on or more lithium-ion (preferably rechargeable) batteries. The battery bank 24 may be shaped generally cylindrical, as shown in FIG. 11, to fit within the housing 14, but may have other shapes as well. Desirably, the thickness t of the battery bank 24 may be in the range of between about 18-19 mm thick. The battery bank 24 may, for example, be able to hold 3.7 V or 3350 mAh of charge with a pulse current of 12 A.

In one embodiment, the battery bank 24 may be used to supply power to the flashlight 10. In another embodiment, the battery bank 24 may also be used as a power bank to supply power to external electric devices via a charge cable electrically coupled to the power connector port 20. As can be appreciated, the power connector port 20 may be configured to receive a USB-C (USB Type-C) connector used in many electronic devices. Other types of connectors are also contemplated, including micro-USB and USB connectors used with other electronic devices. Alternatively, the power connector port 20 may be configured to receive a Lightning® connector used in Apple® iPhone® mobile devices. As can be appreciated, the power connector port 20 may also be used to couple the battery bank 24 to a power supply to recharge the batteries.

The one or more sensors 26 may be used to detect physical conditions, e.g., environment, in which the flashlight 10 is operated or exposed. For example, the one or more sensors 26 may include a heat sensor, a motion sensor, a temperature sensor, a GPS locator, and a pedometer. Other types of sensors may also be suitable. As can be appreciated, the motion sensor may be configured, for example, as a 3-axis accelerometer to optionally measure static acceleration (such as gravity), tilt of an object, dynamic acceleration, velocity, orientation and vibration of the object. Other known or developed sensors may also be employed to provide desired functionality to flashlight 10, such as temperature sensors, light sensors, magneto sensors, gyrometers, CO₂ sensors, etc. In one embodiment, the control switch 16c may be used to select a mode that actuates the operation of the one or more sensors 26. Other control switches may be employed to control the selection and actuation of the one or more sensors 26.

The data produced from the one or more sensors 26 may include, for example, temperature data, acceleration data, location and/or Global Positioning Satellite (GPS) coordinate data, pedometer data, or any combination of any of the foregoing. The data may be processed by the processor 28 and stored in memory 30. Other data relating to the flashlight 10 may also be stored in memory 30 and may be utilized by the processor 28 including, for example, model number data, part number data, serial number data, manufacturing data, electrical power source data, battery data, electrical power source charging data, battery charging data, operating time data, operating mode data, user operating mode settings, control switch 16 actuation data, voltage data, current data, processor data, firmware data, failure data, diagnostic data, among others, or any combination of any of the foregoing.

Memory 30 may include non-volatile read-only memory and/or non-volatile read/write memory as may be desired. For example, data stored by the manufacturer, e.g., model and part number, serial number and date of manufacture may be stored in a read-only memory such as an EPROM as might operating firmware, whereas other data, e.g., operating data, GPS coordinate data, temperature data and settings, may be stored in non-volatile memory such as RAM. All data could be stored in a memory that may be a part of processor 28 or may be wholly or partly separate therefrom.

The processor 28 may be utilized to process data from the one or more sensors 26 and/or the memory 30. As can be appreciated, the processor 28 may be a micro-controller, a microprocessor, a CPU, a processing device on a chip, or equivalent, which may be operatively coupled, for example, to the battery bank 24, the one or more sensors 26, the memory 30, the wireless communication circuitry 32, a DC-DC switch (not shown), the battery charging and control circuitry 36, the light source 22, the control switches 16 and the speaker 18. In one embodiment, the processor 28 may be a system-on-chip, such as Nordic Semiconductor's nRF52840 SoC with integrated Bluetooth 5 capability (including long range and high throughput modes), advanced IoT security, and a Cortex-M Series processor.

In one embodiment, the wireless communication circuitry 32 may be configured for transmission of radio frequency signals conforming to the Bluetooth and/or Wi-Fi standards. Bluetooth-enabled devices, such as mobile devices that employ Bluetooth circuitry, are capable of being paired with peripherals that conform to the Bluetooth standard. The resulting link between paired devices is often referred to as a peer-to-peer network. Thus, the wireless communication link formed between the wireless communication circuitry 32 of the flashlight 10 and the mobile device is a peer-to-peer network. Similarly, Wi-Fi enabled devices, employing Wi-Fi circuitry, are also capable of connecting with peripherals that conform to the WiFi standard, thereby establishing a wireless communication link between the devices. In another exemplary embodiment, the wireless communication circuitry 32 may be configured to transmit radio frequency for wireless mobile communication, such as 3G, 4G or 5G or other wireless mobile communication technology of higher specification, to a mobile device employing wireless mobile communication circuitry. For example, the wireless communication circuitry 32 may be a Qualcomm MDM9206 LTE chipset with 3G/4G multimode and multiband support and may integrate LTE Cat-M1 LTE technology, 2G GSM/GPRS cellular technology, Wi-Fi enabled for 802.11ac standard technology and Bluetooth enabled for Bluetooth standard 4.1 technology. Alternatively, the wireless communication circuitry 32 may be a Quectel BG96 or BG95 chipset with LTE Cat-M1 LTE technology and, optionally, with LTE Narrowband IoT (NB-IoT) (also known as LTE Cat NB1) technology.

In one embodiment, the components disclosed herein may be provided on one or more printed circuit boards (or “PCBs”), which may contain such items as a controller, firmware, an authentication chip, a battery charging and control circuitry 36, among others. For example, the flashlight 10 may include a first PCB to control the light source 22, the wireless communication circuitry and the sensor 26 operations, and a second PCB to control the connector port 20 and battery charging and control circuitry 36. The first PCB may be electrically connected to the second PCB, for example, via a one or more wires or connectors. In an alternative embodiment, the components of the first PCB and the second PCB may be integrated onto a single PCB.

In one embodiment, the DC-DC switch may be integrated in the battery charging and control circuitry 36. As can be appreciated, the battery charging and control circuitry 36 may be configured to (a) receive a 5V charge via the power connector port 20; (b) control DC voltages in the flashlight 10 via the external 5V or from battery bank 24; (c) charge and/or manage the capacity of the battery bank 24; (d) control the operation of the battery bank 24; (e) control the charge-in and charge-out operation through the power connector port 20; and (f) adjust the usage or power intensity of the light source 22 when the battery bank 24 is being used to charge an external device (not shown). In one embodiment, the battery charging and control circuitry 36 may be configured to stop or halt power output to an external device if the capacity of the battery bank 24 is at or below a predetermined charge capacity (i.e., value set within the range between 5% charge capacity and 30% charge capacity) in order to preserve some battery charge for maintaining the operations of the flashlight 10.

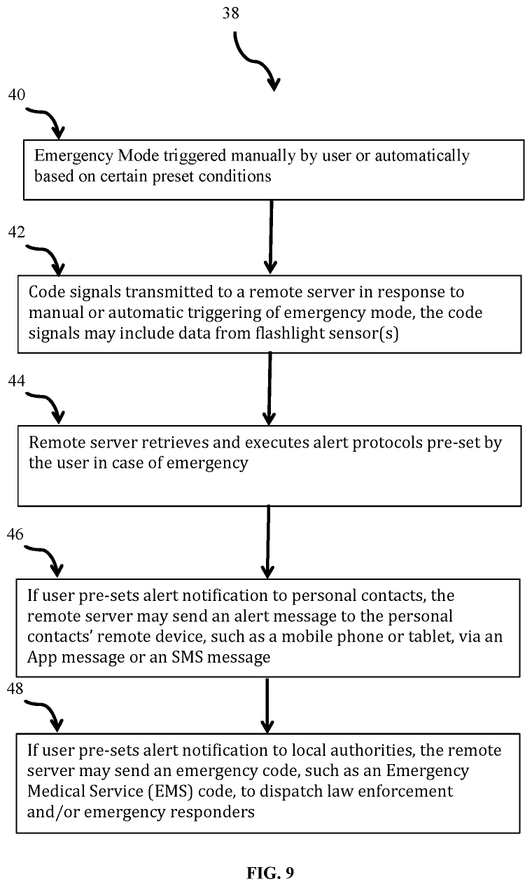

FIG. 9 is a flowchart 38 illustrating exemplary operational features of a communication system for alert notification, according to an embodiment. As noted above, an emergency mode may be triggered manually by the user, for example, by actuating one or more switches 16, or automatically based on certain preset conditions (40). Automatic preset conditions may include, for example, a fall or collision detection by the accelerometer or a detection of high-temperature by the temperature sensor (i.e. may be due to a fire in the vicinity). As such, if the temperature is above a certain temperature threshold (i.e., 50 degrees Celsius), then the emergency mode is triggered automatically. Likewise, if the accelerometer detects abrupt change in elevation by a certain number of feet (which may be indicative of a fall) or a significant vibration (which may be indicative of a car collision), then the emergency mode is triggered automatically. The abrupt change may be determined by a detection of a certain change in elevation within a predetermined period or a detection of acceleration in the x, y and z axis. As one example, an abrupt change may be determined by a detection of an acceleration of 9.8 m/s², reflecting a freefall. Other parameters may be used for acceleration or elevation detection. As can be appreciated, data from the accelerometer and/or temperature sensor 26 is processed by the processor 28 to determine if the data satisfies the preset conditions in order to automatically trigger the emergency mode in the flashlight 10.

Once the emergency mode is triggered, the processor 28 transmits code signals, via the wireless communication circuitry 32, to a remote server (i.e. server 60 in FIG. 10) (42). For example, the wireless communication circuitry 32 may transmit code signals using 3G, 4G or 5G or other wireless mobile communication technology of higher specification, to the remote server. The code signals may include the data from the one or more sensors 26, for example, GPS location data, temperature data and acceleration data.

The remote server may then retrieve and execute alert protocols or settings associated with the flashlight 10 (44). As can be appreciated, these alert protocols or settings may be pre-set by the user in the case of an emergency. In one embodiment, the user may pre-set these alert protocols by selecting options and/or inputting information on a user account online. In another embodiment, the user may pre-set these alert protocols by selecting options and inputting information on a mobile phone App (application software). The options to select may include whether to contact personal contacts and/or local authorities in the case of an emergency. The information inputted may include the mobile phone numbers of one or more personal contacts.

The information inputted and/or selections made may be transmitted to the remote server for storage in a remote storage medium and for retrieval from the remote storage medium when the emergency mode is triggered. If the user pre-sets alert notification to personal contacts, the remote server may send an alert message to the personal contacts' remote device, such as a mobile phone or tablet, via an App message or SMS message (46). Also, if the user pre-sets alert notification to local authorities, the remote server may send, for example, an emergency code, such as an Emergency Medical Service (EMS) code, to dispatch law enforcement and/or emergency responders (i.e. paramedics).

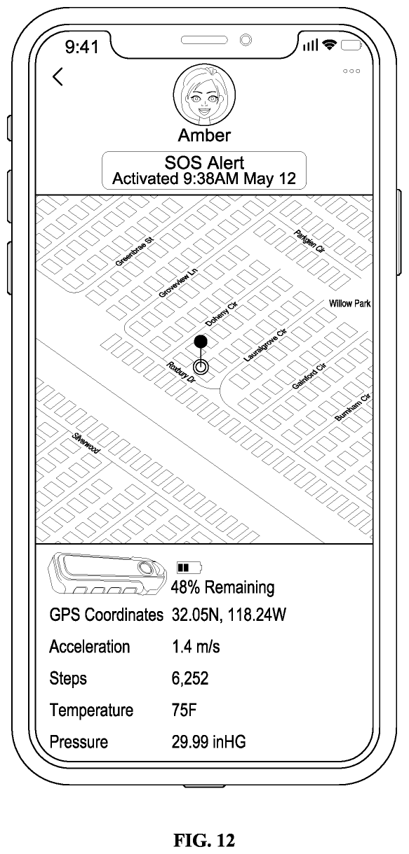

As can be appreciated, the triggering of the emergency mode facilitates alert notification to personal contacts and/or local authorities so that the user of the flashlight 10 may get prompt help for his or her emergency situation. The alert notification to the local authorities and/or the personal contacts may include data from the one or more sensors 26, for example, GPS location data, temperature data and acceleration data, and can be compiled and displayed in a manner as shown in FIG. 12.

FIG. 10 is an exemplary block diagram of a communication system for alert notification, according to an embodiment. The system may include a portable device, (such as flashlight 10), a remote server 60 and an external communication device 62, such as a mobile phone, and/or other external connected devices 64 (for example, utilizing Bluetooth Low Energy (“BLE”)), which may be running an application software App (i.e. mobile phone App). The portable device may utilize the wireless communication circuitry 32 to transmit and receive data to or from the remote server 60 and/or the mobile phone App (application software) residing on an external communication device 62 and/or other external connected devices 64. In one embodiment, the transmission of data may be sent via SMS or internet connection. As can be appreciated, data stored in memory 30 or detected from the one or more sensors 26 may be optionally transmitted to the mobile phone App via the wireless communication circuitry 32. In one embodiment, the mobile phone App may synthesize the data and/or display on the mobile device. Optionally, the remote server 60 synthesizes the sensor data and transmit to the mobile phone for display on the mobile phone App. For example, as shown in FIG. 12, GPS data may be mapped on a digital map (i.e. Google map) and displayed on the mobile device, along with the emergency alert notification. Other conditions may also be detected by the portable device 10 and displayed on the mobile device App, including temperature, acceleration, steps and pressure, as shown in FIG. 12.

As noted above, the portable device 10 may include wireless communication circuitry 36, at least one sensor 26 and a processor 28. The processor 28 may be configured to receive an input signal associated with an activation of an emergency mode, and in response to the receipt of the input signal, transmit an output signal for transmission on the wireless communication circuitry, the output signal comprising the sensor data from the at least one sensor and an identification information of the portable device. The remote server 60 may be wirelessly coupled to the portable device 10 through a wireless link. The remote server 60 may be configured to receive the output signal from the wireless communication circuitry 36 of the portable device 10, retrieve from a storage medium a user's emergency alert settings based on the identification information of the portable device, and transmit an alert notification based on the emergency alert settings. In one embodiment, the mobile phone App may run on an external communication device, which is wirelessly coupled to the remote server 60. The mobile phone App may receive the alert notification from the remote server 60, which may include the sensor data from the at least one sensor 26.

In an embodiment, the flashlight 10 may employ multiple active reporting modes to report status, for example, to the mobile App. For instance, the flashlight may employ a constant reporting mode, a timed reporting mode and/or a trip reporting mode. The reporting may be any predetermined or preset parameters for reporting. The constant reporting mode may actuate the flashlight 10 to remain up all the time (i.e. not in sleep mode) and the report is sent in a pre-determined interval. The time reporting mode may actuate the flashlight 10 to enter constant reporting mode during configured time periods (i.e. start-time and end-time), which can be as multiple periods over multiple days. Finally, the trip reporting mode may actuate the flashlight 10 to report when the flashlight 10 is in motion, which takes place when the accelerometer detects movement of the device. If the flashlight 10 is stationary, the reporting would terminate.

As can be appreciated, the flashlight 10 may be IP67 waterproof compliant. In one embodiment, the flashlight 10 may include latching clips 66 to hold the two halves 68 and 70 of the housing 14 with fluid dispensing for the seam. In another embodiment, the speaker 18 may include a waterproof sound-permeable membrane. In yet another embodiment, the flashlight 10 may include an air vent 72 with waterproof-breathable membrane.

The flashlight 10 may also include a protective coating for water-resistance or water-proofing. In one embodiment, the flashlight 10 may be IP67 compliant. For example, the flashlight 10 may include a polymeric coating formed using a continuous plasma comprising a compound of CH₂═C(R₁)—COO—R₂, where R₁ includes —H or —CH₃; and where R₂ includes —(CH₂)₂—(CF₂)ₘ—CF₃ and m is 3 or 5, as disclosed in U.S. Pat. No. 8,852,693, whose contents are incorporated by reference in their entirety. Artisans would appreciate that other commercially available compounds may be used for forming a polymeric coating on the surface of the flashlight 10. In one embodiment, the protective coating has a thickness between about 250 nm and about 500 nm.

In one embodiment, the protective coatings may have an oleophobicity level of about at least 5, suitably between about level 5 to about level 10, including every level therebetween, such as about levels 5, 6, 7, 8, 9 or 10. Additionally, the coating can provide a water contact angle of at least 100°. In one aspect, the coating can provide a water contact angle between about 100° to about 120°. Such characteristics of the coating can help protect against pollutants and contamination, including water or moisture contamination. In one embodiment, the coating can protect against liquid damage. In another aspect, the contamination or liquid damage can be water.

The coating material may also be an antimicrobial coating. As will be appreciated by those skilled in the art, antimicrobial coatings may include additives such as silver, zinc, tin mercury, lead, iron, cobalt, nickel, manganese, arsenic, antimony, bismuth, barium, cadmium and chromium. Exemplary antimicrobial coatings may include, for example, those disclosed in U.S. Publ. Nos. US20060222845, US20070259307, US20110206817, US20090202656, US20090182337, and US20110311591, and in U.S. Pat. Nos. 8,080,028, 6,238,686, 5,770,255, 5,753,251, 5,681,575, 8,084,132, 7,884,089, 7,625,579, 7,955,636, 5,066,328, 8,124,169, 4,933,178, 8,066,854, 6,929,705, 5,997,815, 7,282,214, 7,976,863, 6,514,517, 5,238,749, 8,137,735, 6,592,814, 8,172,395, 7,402,318, 8,133,423, 5,853,745, 6,565,913, 8,178,120, 6,361,567, 5,756,145, 7,641,912, 6,900,265 and 5,244,667, each of which is incorporated by reference herein in its entirety. The coating material may also be a fire-resistant coating. Suitable fire-resistant coatings include, for example, those disclosed in U.S. Pat. Nos. 5,322,555, 5,236,773, U.S. Publ. No. US20060083878, and PCT Appl. No. PCT/EP2000/004914, each of which is incorporated by reference herein in its entirety. The coating material may also be a scratch resistant coating. Suitable scratch resistant coatings may include, for example, those disclosed in U.S. Pat. Nos. 7,867,602, 5,837,362, 6,025,059, 7,264,669, 7,115,050, 6,916,368, 6,020,419, 6,803,408, 6,835,420, 6,759,478, 8,163,357, 6,387,519, 7,053,149, 7,662,433, and 7,871,690, and U.S. Publ. Nos. US20120100380, US20110097574, US20100119802, US20110058142, US20120121845, US20120003483, and US20110151218, each of which is incorporated by reference herein in its entirety.

Although the various inventive aspects are herein disclosed in the context of certain preferred embodiments, implementations, and examples, it will be understood by those skilled in the art that the present invention extends beyond the specifically disclosed embodiments to other alternative embodiments and/or uses of the invention and obvious modifications and equivalents thereof. In addition, while a number of variations of the inventive aspects have been shown and described in detail, other modifications, which are within their scope will be readily apparent to those of skill in the art based upon this disclosure. It should be also understood that the scope this disclosure includes the various combinations or sub-combinations of the specific features and aspects of the embodiments disclosed herein, such that the various features, modes of implementation, and aspects of the disclosed subject matter may be combined with or substituted for one another. Thus, it is intended that the scope of the present invention herein disclosed should not be limited by the particular disclosed embodiments or implementations described above, but should be determined only by a fair reading of the claims.

Similarly, this disclosure is not be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

Further, all claim terms should be interpreted in their most expansive forms so as to afford the applicant the broadest coverage legally permissible. Although the embodiments have been described with reference to the drawings and specific examples, it will readily be appreciated by those skilled in the art that many modifications and adaptations of the processes, methods and apparatuses described herein are possible without departure from the spirit and scope of the embodiments as claimed herein. Thus, it is to be clearly understood that this description is made only by way of example and not as a limitation on the scope of the embodiments as claimed below.

What is claimed is:

1. An alert notification system comprising:
a portable device, the portable device comprising
wireless communication circuitry,
at least one sensor configured to detect a condition in which the portable device is exposed and to output an associated sensor data, the at least one sensor comprising a Global Positioning Satellite (GPS) locator,
a processor operatively coupled to the at least one sensor and the wireless communication circuitry, the processor configured to receive an input signal associated with an activation of an emergency mode, and in response to the receipt of the input signal, transmit an output signal for transmission by the wireless communication circuitry, the output signal comprising the sensor data from the at least one sensor and an identification information of the portable device;
a remote server wirelessly coupled to the portable device, the remote server configured to receive the output signal from the wireless communication circuitry of the portable device, retrieve from a storage medium a user's emergency alert setting based on the identification information of the portable device, and transmit an alert notification based on the emergency alert setting; and
an external communication devices wirelessly coupled to the remote server, and configured to receive the alert notification from the remote server, the alert notification comprising the sensor data from the at least one sensor.

2. The alert notification system of claim 1, wherein the portable device is a portable flashlight.

3. The alert notification system of claim 1, wherein the remote server transmits an emergency medical service code to alert local authorities.

4. The alert notification system of claim 1, wherein the emergency alert setting includes a mobile phone number of at least one emergency contact, the remote server transmitting the alert notification to the at least one emergency contact by an SMS message.

5. The alert notification system of claim 1, wherein the at least one sensor further comprises a temperature sensor, an accelerometer, a pedometer, or any combination of any of the foregoing.

6. The alert notification system of claim 1, wherein the portable device further comprises at least one control switch, the at least one control switch configured for activation of the emergency mode.

7. The alert notification system of claim 5, wherein the activation of the emergency mode is triggered automatically based on a predetermined condition, the predetermined condition is selected from a group consisting of a detection by the temperature sensor of a temperature above a certain temperature threshold level, a detection by the accelerometer of a certain change in elevation within a predetermined period, and a detection by the accelerometer of a vibration above a certain threshold level.

8. A portable lighting device comprising:
a housing having a proximal end and a distal end, the housing defining a hollow cavity;
a light source disposed at the proximal end of the housing;
at least one control switch disposed in the cavity of the housing and configured for activation of an emergency mode;
wireless communication circuitry disposed in the cavity of the housing and configured for wireless transmission through a wireless link;
at least one sensor disposed in the cavity of the housing and configured to detect a condition in which the portable device is exposed and to output an associated sensor data, the at least one sensor comprising an accelerometer and a Global Positioning Satellite (GPS) locator; and
a processor operatively coupled to the at least one control switch, the at least one sensor and the wireless communication circuitry, the processor configured to receive a signal from the at least one control switch for activation of the emergency mode, and send an associated output signal for transmission by the wireless communication circuitry, the associated output signal comprising the sensor data from the at least one sensor and an identification information of the portable device.

9. The portable lighting device of claim 8, wherein the light source emits an SOS distress lighting pattern when the emergency mode is activated.

10. The portable lighting device of claim 8, wherein the at least one sensor further comprises a temperature sensor.

11. The portable lighting device of claim 10, wherein the activation of the emergency mode is triggered automatically based on a predetermined sensor condition, the predetermined sensor condition is selected from a group consisting of a detection by the temperature sensor of a temperature above a certain temperature threshold level, a detection by the accelerometer of a certain change in elevation within a predetermined period of time, and a detection by the accelerometer of a vibration above a certain threshold level.

12. The portable lighting device of claim 8, wherein the output signal is transmitted by the wireless communication circuitry to an external communication device through the wireless link, the output signal providing an alert notification at the external communication device, the alert notification comprising the sensor data from the at least one sensor.

13. The portable lighting device of claim 12, wherein the alert notification is provided as a software application message or an SMS message.

14. The portable lighting device of claim 8, further comprising a rechargeable battery electrically coupled to the light source, wherein the wireless communication circuitry further configured to transmit a battery condition information of the rechargeable battery to an external communication device through the wireless link.

15. The portable lighting system of claim 8, wherein the wireless communication circuitry is selected from a group consisting of Bluetooth circuitry, Wi-Fi circuitry and wireless mobile communication circuitry.

16. A portable device comprising:
a housing defining a hollow cavity;
wireless communication circuitry disposed in the cavity of the housing and configured for wireless transmission through a wireless link;
at least one sensor disposed in the cavity of the housing and configured to detect a condition in which the portable device is exposed and to output an associated sensor data, the at least one sensor comprising an accelerometer and a Global Positioning Satellite (GPS) locator; and
a processor operatively coupled to the at least one sensor and the wireless communication circuitry, the processor configured to:
receive the sensor data from the at least one sensor,
automatically activate an emergency mode based on a predetermined sensor condition, the predetermined sensor condition comprising sensor data associated with a detection by the accelerometer of a certain change in elevation within a predetermined period, and
automatically send an output signal for transmission by the wireless communication circuitry, the output signal comprising the sensor data from the at least one sensor and an identification information of the portable device.

17. The portable device of claim 16, wherein the predetermined sensor condition further comprises sensor data associated with a detection by the accelerometer of a vibration above a certain threshold level.

18. The portable device of claim 16, wherein the at least one sensor further comprises a temperature sensor, the predetermined sensor condition further comprises sensor data associated with a detection by the temperature sensor of a temperature above a certain temperature threshold level.

19. The portable device of claim 16, further comprising a light source, the light source emits an SOS distress lighting pattern when the emergency mode is activated.

20. The portable device of claim 16, wherein the output signal is transmitted by the wireless communication circuitry to an external communication device through the wireless link, the output signal providing an alert notification at the external communication device via a software application message or an SMS message.
